(19) United States
(12) Patent Application Publication
(10) Pub. No.: US 2026/0288201 A1
(43) Pub. Date: Sep. 24, 2026

(54) WEARABLE DEVICE AND METHOD FOR DISPLAYING ONE OR MORE VIRTUAL OBJECTS FOR ENTERING VIRTUAL SPACES, AND COMPUTER-READABLE STORAGE MEDIUM

(71) Applicant: SAMSUNG ELECTRONICS CO., LTD., Suwon-si (KR)

(72) Inventors: Moonyong JEONG, Suwon-si (KR); Eunkyung LEE, Suwon-si (KR)

(21) Appl. No.: 19/684,864

(22) Filed: May 21, 2026

Related U.S. Application Data
(63) Continuation of application No. PCT/KR2024/015490, filed on Oct. 14, 2024.

(30) Foreign Application Priority Data
Nov. 22, 2023 (KR) 10-2023-0163862

(51) Int. Cl. G06F 1/16; G02B 27/00; G02B 27/01; G06F 3/01; G06F 3/04815; G06F 3/04817; G06F 3/04845

(52) U.S. Cl. CPC G06F 1/163; G02B 27/0093; G02B 27/0172; G06F 3/013; G06F 3/017; G06F 3/04815; G06F 3/04817; G06F 3/04845; G02B 2027/0138; G02B 2027/014; G02B 2027/0178

(57) ABSTRACT

A wearable device according to one embodiment may comprise: at least one sensor; a display; a memory for storing instructions; and a processor. When executed by the processor, the instructions can cause the wearable device to: on the basis of identifying an input for executing a second application while a first virtual space corresponding to a first application is displayed on the display, display, in the first virtual space, a first virtual object for entering a second virtual space corresponding to the second application; and display the second virtual space on the display on the basis of an input for switching to the second virtual space through the first virtual object.

### CROSS-REFERENCE TO RELATED APPLICATIONS

This application is a continuation of International Application No. PCT/KR2024/015490 designating the United States, filed on Oct. 14, 2024, in the Korean Ministry of Intellectual Property Receiving Office and claiming priority to Korean Patent Application No. 10-2023-0163862, filed on Nov. 22, 2023, the disclosures of each of which are incorporated by reference herein in their entireties.

### BACKGROUND

### (1) Field

Various embodiments described below relate to a wearable device, a method, and a computer readable storage medium for displaying one or more virtual objects for entry into virtual spaces.

### (2) Description of the Related Art

In order to provide an enhanced user experience, an electronic device that provides an augmented reality (AR) service for displaying information generated by a computer in association with an external object in the real world is being developed. The electronic device may be a wearable device that may be worn by a user. For example, the electronic device may be AR glasses and/or a head-mounted device (HMD).

The above-described information may be provided as related art for the purpose of helping the understanding of the present disclosure. No claim or determination is raised as to whether any of the above-described content may be applied as prior art related to the present disclosure.

### SUMMARY

According to an embodiment, a wearable device may comprise at least one sensor, a display, memory comprising one or more storage media storing instructions, and at least one processor comprising processing circuitry. The instructions, when executed by the at least one processor individually or collectively, may cause the wearable device to identify at least one application being executed while a first virtual space corresponding to a first application is displayed on the display. The instructions, when executed by the at least one processor individually or collectively, may cause the wearable device to, based on identifying an input for executing a second application, display a first virtual object for entry into a second virtual space corresponding to the second application within the first virtual space. The instructions, when executed by the at least one processor individually or collectively, may cause the wearable device to, based on an input for switching to the second virtual space through the first virtual object, display the second virtual space on the display. The instructions, when executed by the at least one processor individually or collectively, may cause the wearable device to, in response to identifying the switching to the second virtual space, display a second virtual object for entry into the first virtual space on the display.

According to an embodiment, a method of a wearable device may comprise identifying at least one application being executed while a first virtual space corresponding to a first application is displayed on a display of the wearable device. The method may comprise, based on identifying an input for executing a second application, displaying a first virtual object for entry into a second virtual space corresponding to the second application within the first virtual space. The method may comprise, based on an input for switching to the second virtual space through the first virtual object, displaying the second virtual space on the display. The method may comprise, in response to identifying the switching to the second virtual space, displaying a second virtual object for entry into the first virtual space on the display.

According to an embodiment, in a non-transitory computer readable storage medium storing one or more programs, the one or more programs may include instructions that, when executed by at least one processor of a wearable device with a display and at least one sensor, individually or collectively, cause the wearable device to identify at least one application being executed while a first virtual space corresponding to a first application is displayed on the display. The one or more programs may include instructions that, when executed by the at least one processor individually or collectively, cause the wearable device to, based on identifying an input for executing a second application, display a first virtual object for entry into a second virtual space corresponding to the second application within the first virtual space. The one or more programs may include instructions that, when executed by the at least one processor individually or collectively, cause the wearable device to, based on an input for switching to the second virtual space through the first virtual object, display the second virtual space on the display. The one or more programs may include instructions that, in response to identifying the switching to the second virtual space, cause the wearable device to display a second virtual object for entry into the first virtual space on the display.

### BRIEF DESCRIPTION OF THE DRAWINGS

FIG. 1 is a block diagram of an electronic device in a network environment according to an embodiment.

FIG. 2A and FIG. 2B illustrate an example of a perspective view of a wearable device according to an embodiment.

FIGS. 3A and 3B illustrate an example of an exterior of a wearable device according to an embodiment.

FIG. 4 illustrates an example of a block diagram of a wearable device according to an embodiment.

FIG. 5A illustrates an exemplary virtual space displayed through a display.

FIG. 5B illustrates an example of an application within a virtual space displayed according to a direction of a gaze of a user.

FIG. 5C and FIG. 5D illustrate an exemplary virtual space for execution of at least one application.

FIG. 6A, FIG. 6B, and FIG. 6C illustrate an example in which a virtual space is switched.

FIG. 7 is a flow chart illustrating an exemplary operation of a wearable device for switching a virtual space.

FIG. 8A, FIG. 8B, and FIG. 8C illustrate an exemplary virtual space displayed through a display.

FIG. 9 illustrates an example of virtual objects disposed within a virtual space according to a user input.

### DETAILED DESCRIPTION

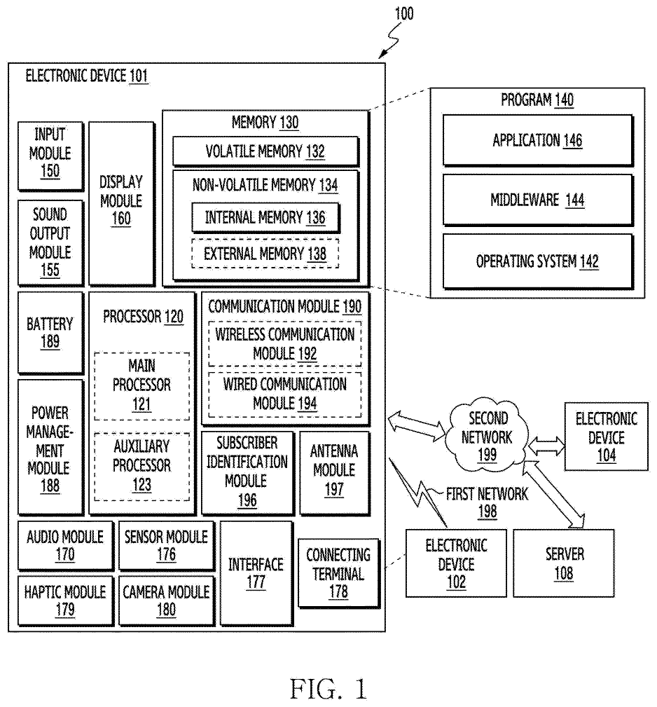

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

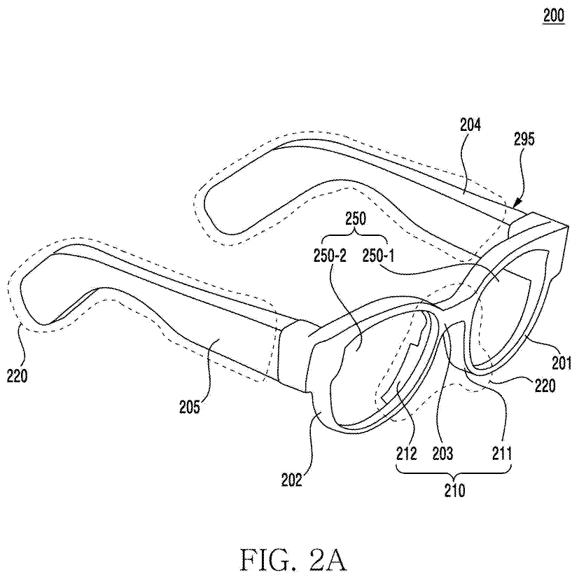

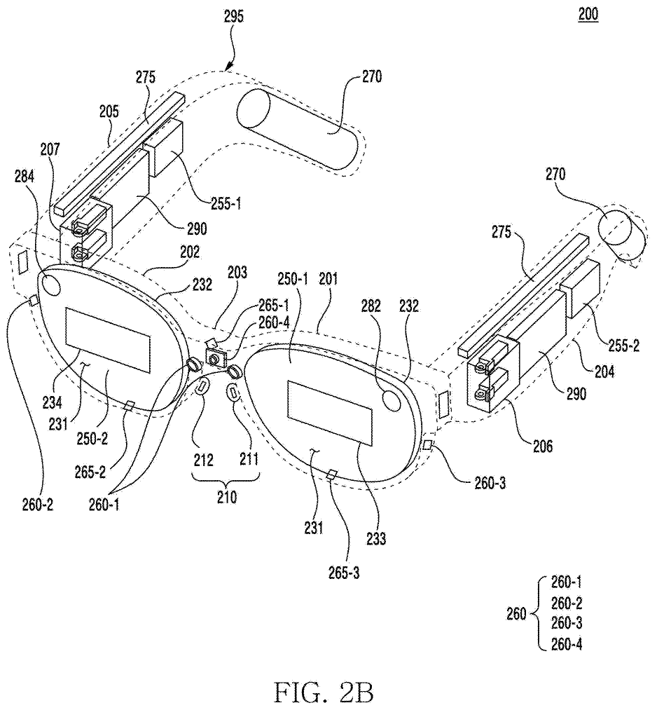

FIGS. 2A and 2B illustrate an example of a perspective view of a wearable device according to an embodiment.

According to an embodiment, a wearable device 200 may have a form of glasses that is wearable on a body part (e.g., head) of a user. The wearable device 200 of FIGS. 2A to 2B may be an example of the electronic device 101 of FIG. 1. The wearable device 200 may include a head-mounted display (HMD). For example, a housing of the wearable device 200 may include a flexible material such as rubber and/or silicone having a form closely attached to a portion of the user's head (for example, a portion of a face surrounding two eyes). For example, the housing of the wearable device 200 may include one or more straps able to be twined around the user's head, and/or one or more temples attachable to ears of the head.

Referring to FIG. 2A, according to an embodiment, the wearable device 200 may include at least one display 250 and a frame 295 supporting the at least one display 250.

According to an embodiment, the wearable device 200 may be wearable on a portion of the user's body. The wearable device 200 may provide augmented reality (AR), virtual reality (VR), or mixed reality (MR) combining the augmented reality and the virtual reality to a user wearing the wearable device 200. For example, the wearable device 200 may display a virtual reality image provided from at least one optical device 282 and 284 of FIG. 2B on at least one display 250, in response to a user's preset gesture obtained through a motion recognition camera 260-2 and 260-3 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may provide visual information transmitted through a lens included in the at least one display 250 from ambient light to a user and other visual information distinguished from the visual information2. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the wearable device 200, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

According to an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 200 to guide a screen displayed by the at least one display 250 to the user's eyes. For example, the screen may be transmitted to the user's eyes based on total internal reflection (TIR) generated in the at least one waveguide 233 and 234.

The wearable device 200 may analyze an object included in a real image collected through a photographing camera 260-4, combine with a virtual object corresponding to an object that becomes a subject of augmented reality provision among the analyzed object, and display on the at least one display 250. The virtual object may include at least one of text and images for various information associated with the object included in the real image. The wearable device 200 may analyze the object based on a multi-camera such as a stereo camera. For the object analysis, the wearable device 200 may execute space recognition (e.g., simultaneous localization and mapping (SLAM)) using the multi-camera and/or time-of-flight (ToF). The user wearing the wearable device 200 may watch an image displayed on the at least one display 250.

According to an embodiment, a frame 295 may be configured with a physical structure in which the wearable device 200 may be worn on the user's body. According to an embodiment, the frame 295 may be configured so that when the user wears the wearable device 200, the first display 250-1 and the second display 250-2 may be positioned corresponding to the user's left and right eyes. The frame 295 may support the at least one display 250. For example, the frame 295 may support the first display 250-1 and the second display 250-2 to be positioned at positions corresponding to the user's left and right eyes.

Referring to FIG. 2A, according to an embodiment, the frame 295 may include an area 220 at least partially in contact with the portion of the user's body in case that the user wears the wearable device 200. For example, the area 220 of the frame 295 in contact with the portion of the user's body may include an area in contact with a portion of the user's nose, a portion of the user's ear, and a portion of the side of the user's face that the wearable device 200 contacts. According to an embodiment, the frame 295 may include a nose pad 210 that is contacted on the portion of the user's body. When the wearable device 200 is worn by the user, the nose pad 210 may be contacted on the portion of the user's nose. The frame 295 may include a first temple 204 and a second temple 205, which are contacted on another portion of the user's body that is distinct from the portion of the user's body.

For example, the frame 295 may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the wearable device 200 may identify an external object (e.g., a user's fingertip) touching the frame 295 and/or a gesture performed by the external object by using a touch sensor, a grip sensor, and/or a proximity sensor formed on at least a portion of the surface of the frame 295.

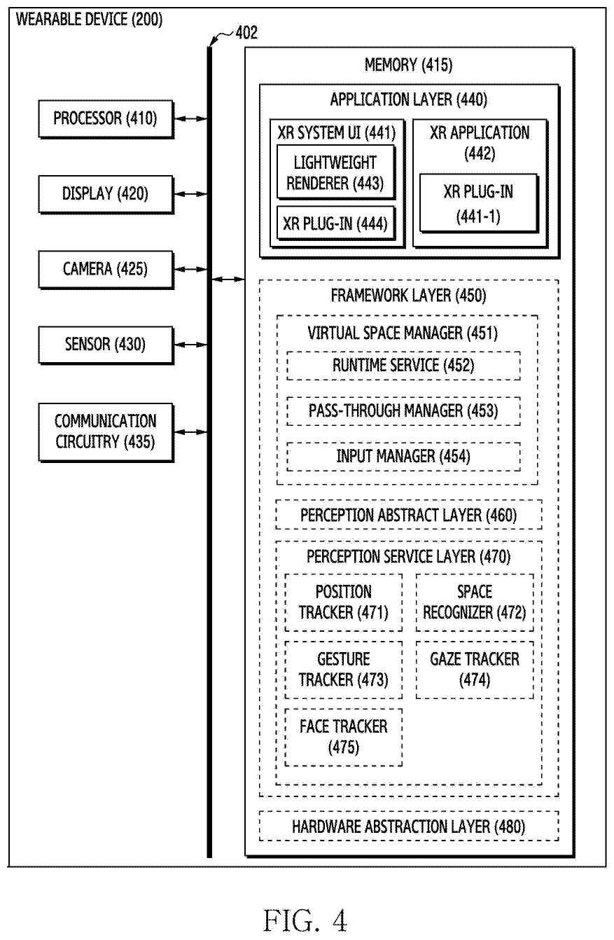

According to an embodiment, the wearable device 200 may include hardware (e.g., hardware to be described later based on the block diagram of FIG. 4) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 295.

According to an embodiment, the microphone (e.g., the microphones 265-1, 265-2, and 265-3) of the wearable device 200 may obtain a sound signal, by being disposed on at least a portion of the frame 295. The first microphone 265-1 disposed on the bridge 203, the second microphone 265-2 disposed on the second rim 202, and the third microphone 265-3 disposed on the first rim 201 are illustrated in FIG. 2B, but the number and disposition of the microphone 265 are not limited to an embodiment of FIG. 2B. In case that the number of the microphone 265 included in the wearable device 200 is two or more, the wearable device 200 may identify a direction of the sound signal by using a plurality of microphones disposed on different portions of the frame 295.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the wearable device 200 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 295 and may perform different functions. The eye tracking camera 260-1 may output data indicating a position of eye or a gaze of the user wearing the wearable device 200. For example, the wearable device 200 may detect the gaze from an image including the user's pupil obtained through the eye tracking camera 260-1. The wearable device 200 may identify an object (e.g., a real object, and/or a virtual object) focused by the user, by using the user's gaze obtained through the eye tracking camera 260-1. The wearable device 200 identifying the focused object may execute a function (e.g., gaze interaction) for interaction between the user and the focused object. The wearable device 200 may represent a portion corresponding to eye of an avatar indicating the user in the virtual space, by using the user's gaze obtained through the eye tracking camera 260-1. The wearable device 200 may render an image (or a screen) displayed on the at least one display 250, based on the position of the user's eye. For example, visual quality (e.g., resolution, brightness, saturation, grayscale, and PPI) of a first area related to the gaze within the image and visual quality of a second area distinguished from the first area may be different. The wearable device 200 may obtain an image having the visual quality of the first area matching the user's gaze and the visual quality of the second area by using foveated rendering. For example, when the wearable device 200 supports an iris recognition function, user authentication may be performed based on iris information obtained using the eye tracking camera 260-1. An example in which the eye tracking camera 260-1 is disposed toward the user's right eye is illustrated in FIG. 2B, but the embodiment is not limited thereto, and the eye tracking camera 260-1 may be disposed alone toward the user's left eye or may be disposed toward two eyes.

In an embodiment, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 200 may compensate for depth information (e.g., a distance between the wearable device 200 and an external object obtained through a depth sensor), by using an image obtained through the photographing camera 260-4. The wearable device 200 may perform object recognition through an image obtained using the photographing camera 260-4. The wearable device 200 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 200 may perform a pass through function for displaying an image obtained through the photographing camera 260-4 overlapping at least a portion of the screen. In an embodiment, the photographing camera 260-4 may be disposed on the bridge 203 disposed between the first rim 201 and the second rim 202.

The eye tracking camera 260-1 may implement a more realistic augmented reality by matching the user's gaze with the visual information provided on the at least one display 250, by tracking the gaze of the user wearing the wearable device 200. For example, when the user looks at the front, the wearable device 200 may naturally display environment information associated with the user's front on the at least one display 250 at a position where the user is positioned. The eye tracking camera 260-1 may be configured to capture an image of the user's pupil in order to determine the user's gaze. For example, the eye tracking camera 260-1 may receive gaze detection light reflected from the user's pupil and may track the user's gaze based on the position and movement of the received gaze detection light. In an embodiment, the eye tracking camera 260-1 may be disposed at a position corresponding to the user's left and right eyes. For example, the eye tracking camera 260-1 may be disposed in the first rim 201 and/or the second rim 202 to face the direction in which the user wearing the wearable device 200 is positioned.

The motion recognition camera 260-2 and 260-3 may provide a specific event to the screen provided on the at least one display 250 by recognizing the movement of the whole or portion of the user's body, such as the user's torso, hand, or face. The motion recognition camera 260-2 and 260-3 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment, the motion recognition camera 260-2 and camera 260-3 may be disposed on the first rim 201 and/or the second rim 202.

The camera 260 included in the wearable device 200 are not limited to the above-described eye tracking camera 260-1 and the motion recognition camera 260-2 and 260-3. For example, the wearable device 200 may identify an external object included in the FoV by using a camera disposed toward the user's FoV. The wearable device 200 identifying the external object may be performed based on a sensor for identifying a distance between the wearable device 200 and the external object, such as a depth sensor and/or a time of flight (ToF) sensor. The camera 260 disposed toward the FoV may support an autofocus function and/or an optical image stabilization (OIS) function. For example, in order to obtain an image including a face of the user wearing the wearable device 200, the wearable device 200 may include the camera 260 (e.g., a face tracking (FT) camera) disposed toward the face.

Although not illustrated, the wearable device 200 according to an embodiment may further include a light source (e.g., LED) that emits light toward a subject (e.g., user's eyes, face, and/or an external object in the FoV) photographed by using the camera 260. The light source may include an LED having an infrared wavelength. The light source may be disposed on at least one of the frame 295, and the hinge units 206 and 207.

According to an embodiment, the battery module 270 may supply power to electronic components of the wearable device 200. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the wearable device 200 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

The speaker 255 may output a sound signal to the outside of the wearable device 200. A sound output module may be referred to as a speaker. In an embodiment, the speaker 255 may be disposed in the first temple 204 and/or the second temple 205 in order to be disposed adjacent to the ear of the user wearing the wearable device 200. For example, the speaker 255 may include a second speaker 255-2 disposed adjacent to the user's left ear by being disposed in the first temple 204, and a first speaker 255-1 disposed adjacent to the user's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 200 to the user. For example, when the wearable device 200 requires charging, it may emit red light at a constant cycle. In an embodiment, the light emitting module may be disposed on the first rim 201 and/or the second rim 202.

Referring to FIG. 2B, according to an embodiment, the wearable device 200 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by different blocks of FIG. 4) included in the wearable device 200 may be disposed. The wearable device 200 may include a flexible PCB (FPCB) for interconnecting the hardware.

According to an embodiment, the wearable device 200 may include at least one of a gyro sensor, a gravity sensor, and/or an acceleration sensor for detecting the posture of the wearable device 200 and/or the posture of a body part (e.g., a head) of the user wearing the wearable device 200. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 200 may identify the user's motion and/or gesture performed to execute or stop a specific function of the wearable device 200 based on the IMU.

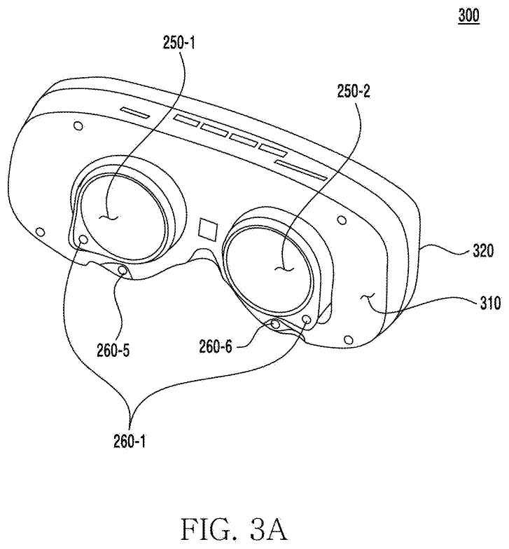

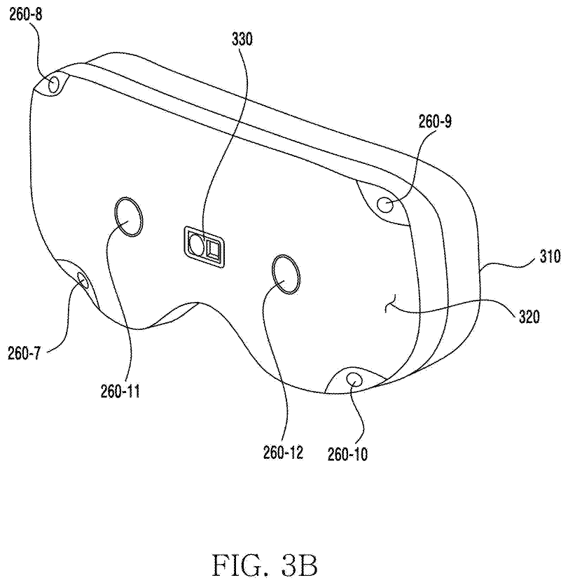

FIGS. 3A and 3B illustrate an example of an exterior of a wearable device according to an embodiment.

A wearable device 300 of FIGS. 3A and 3B may be an example of the electronic device 101 of FIG. 1 and the wearable device 200 of FIGS. 2A and 2B. According to an embodiment, an example of an exterior of a first surface 310 of a housing of the wearable device 300 may be shown in FIG. 3A, and an example of an exterior of a second surface 320 opposite to the first surface 310 may be shown in FIG. 3B.

Referring to FIG. 3A, according to an embodiment, the first surface 310 of the wearable device 300 may have an attachable shape on the user's body part (e.g., the user's face). Although not illustrated, the wearable device 300 may further include a strap for being fixed on the user's body part, and/or one or more temples (e.g., the first temple 204 and/or the second temple 205 of FIGS. 2A to 2B). A first display 250-1 for outputting an image to the left eye among the user's two eyes and a second display 250-2 for outputting an image to the right eye among the user's two eyes may be disposed on the first surface 310. The wearable device 300 may further include rubber or silicon packing, which are formed on the first surface 310, for preventing interference by light (e.g., ambient light) different from the light emitted from the first display 250-1 and the second display 250-2.

According to an embodiment, the wearable device 300 may include cameras 260-1 for photographing and/or tracking two eyes of the user adjacent to each of the first display 250-1 and the second display 250-2. The cameras 260-1 may be referred to as the gaze tracking camera 260-1 of FIG. 2B. According to an embodiment, the wearable device 300 may include cameras 260-5 and 260-6 for photographing and/or recognizing the user's face. The cameras 260-5 and 260-6 may be referred to as a FT camera. The wearable device 300 may control an avatar representing a user in a virtual space, based on a motion of the user's face identified using the cameras 260-5 and 260-6. For example, the wearable device 300 may change a texture and/or a shape of a portion (e.g., a portion of an avatar representing a human face) of the avatar, by using information obtained by the cameras 260-5 and 260-6 (e.g., the FT camera) and representing the facial expression of the user wearing the wearable device 300.

Referring to FIG. 3B, a camera (e.g., cameras 260-7, 260-8, 260-9, 260-10, 260-11, and 260-12), and/or a sensor (e.g., the depth sensor 330) for obtaining information associated with the external environment of the wearable device 300 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

For example, by using cameras 260-11 and 260-12, the wearable device 300 may obtain an image and/or video to be transmitted to each of the user's two eyes. The camera 260-11 may be disposed on the second surface 320 of the wearable device 300 to obtain an image to be displayed through the second display 250-2 corresponding to the right eye among the two eyes. The camera 260-12 may be disposed on the second surface 320 of the wearable device 300 to obtain an image to be displayed through the first display 250-1 corresponding to the left eye among the two eyes. The cameras 260-11 and 260-12 may be referred to as the photographing camera 260-4 of FIG. 2B.

According to an embodiment, the wearable device 300 may include the depth sensor 330 disposed on the second surface 320 in order to identify a distance between the wearable device 300 and the external object. By using the depth sensor 330, the wearable device 200 may obtain spatial information (e.g., a depth map) about at least a portion of the FoV of the user wearing the wearable device 300. Although not illustrated, a microphone for obtaining sound outputted from the external object may be disposed on the second surface 320 of the wearable device 300. The number of microphones may be one or more according to embodiments.

FIG. 4 illustrates an example of a block diagram of a wearable device according to an embodiment.

Referring to FIG. 4, a wearable device 200 according to an embodiment may include at least one of a processor 410, memory 415, a display 420, a camera 425, a sensor 430, or communication circuitry 435. The processor 410, the memory 415, the display 420, the camera 425, the sensor 430, and the communication circuitry 435 may be electronically and/or operably coupled with each other by an electronical component such as a communication bus 402. A type and/or the number of hardware components included in the wearable device 200 is not limited to those illustrated in FIG. 4. For example, the wearable device 200 may include only some of the hardware components illustrated in FIG. 4. Elements (e.g., layers and/or modules) in the memory described below may be logically divided. However, it is not limited thereto.

The processor 410 of the wearable device 200 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of the processors 410 may be one or more. For example, the processor 410 may have a structure of a multi-core processor such as a dual core, a quad core, or a hexa core.

The memory 415 of the wearable device 200 according to an embodiment may include a hardware component for storing data and/or instructions inputted to and/or outputted from the processor 410. The memory 415 may include, for example, volatile memory, such as a random-access memory (RAM), and/or non-volatile memory, such as a read-only memory (ROM). The volatile memory may include, for example, at least one of a dynamic RAM (DRAM), a static RAM (SRAM), a Cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disc, and an embedded multi media card (eMMC).

According to an embodiment, a display 420 of the wearable device 200 may output visualized information to a user of the wearable device 200. For example, the display 420 may be controlled by the processor 410 including a circuit such as a graphic processing unit (GPU) and output visualized information to the user. The display 420 may include a flat panel display (FPD) and/or electronic paper. The FPD may include a liquid crystal display (LCD), a plasma display panel (PDP), and/or one or more light emitting diodes (LEDs). The LEDs may include an organic LED (OLED).

According to an embodiment, a camera 425 of the wearable device 200 may include one or more optical sensors (e.g., a charged coupled device (CCD) sensor, a complementary metal oxide semiconductor (CMOS) sensor) generating an electrical signal indicating color and/or brightness of light. A plurality of optical sensors included in the camera 425 may be disposed in a form of a 2-dimensional array. The camera 425 may obtain electrical signals of each of the plurality of optical sensors substantially simultaneously and generate 2-dimensional frame data corresponding to light reaching the optical sensors of the 2-dimensional array. For example, photo data captured using the camera 425 may indicate a 2-dimensional frame data obtained from the camera 425. For example, video data captured using the camera 425 may indicate a sequence of a plurality of 2-dimensional frame data obtained from the camera 425 according to a frame rate. The camera 425 may further include a flash light disposed toward a direction in which the camera 425 receives light and configured to output light toward the direction.

According to an embodiment, the wearable device 200 may include, as an example of the camera 425, a plurality of cameras disposed toward different directions. Among the plurality of cameras, a first camera may be referred to as a motion recognition camera (e.g., the motion recognition camera 260-2 and 260-3 of FIG. 2B), and a second camera may be referred to as a gaze tracking camera (e.g., the gaze tracking camera 260-1 of FIG. 2B). The wearable device 200 may identify a position, a shape, and/or a gesture of a hand by using an image obtained using the first camera. The wearable device 200 may identify a direction of a gaze of a user wearing the wearable device 200 by using an image obtained using the second camera. As an example, a direction toward which the first camera faces and a direction toward which the second camera faces may be opposite.

According to an embodiment, a sensor 430 of the wearable device 200 may generate electrical information capable of being processed by the processor 410 and/or the memory 415 of the wearable device 200 from non-electronic information related to the wearable device 200. The information may be referred to as sensor data. The sensor 430 may include a global positioning system (GPS) sensor for detecting a geographic location of the wearable device 200, an image sensor, an illuminance sensor and/or a time-of-flight (ToF) sensor, and an inertial measurement unit (IMU) for detecting a physical motion of the wearable device 200.

In an embodiment, the communication circuitry 435 of the wearable device 200 may include a hardware component for supporting transmission and/or reception of an electrical signal between the wearable device 200 and an external electronic device. The communication circuitry 435 may include, for example, at least one of a MODEM, an antenna, or an optic/electronic (O/E) converter. The communication circuitry 435 may support transmission and/or reception of an electrical signal based on various types of protocols, such as Ethernet, local area network (LAN), wide area network (WAN), wireless fidelity (WiFi), Bluetooth, Bluetooth Low Energy (BLE), ZigBee, long term evolution (LTE), 5G new radio (NR), and/or 6G.

According to an embodiment, in the memory 415 of the wearable device 200, one or more instructions (or commands) representing a calculation and/or an operation to be performed on data by the processor 410 of the wearable device 200 may be stored. A set of one or more instructions may be referred to as firmware, an operating system, a process, a routine, a sub-routine, and/or an application. For example, the wearable device 200 and/or the processor 410 may perform at least one of operations according to an embodiment described below, when a set of a plurality of instructions distributed in a form of an operating system, firmware, a driver, and/or an application is executed. Hereinafter, an application being installed in the wearable device 200 may mean that one or more instructions provided in a form of an application are stored in the memory 415, and that the one or more applications are stored in a format (e.g., a file having an extension specified by an operating system of the wearable device 200) executable by the processor 410. As an example, an application may include a program and/or a library associated with a service provided to the user.

Referring to FIG. 4, programs installed in the wearable device 200 may be classified into any one layer among different layers including an application layer 440, a framework layer 450, and/or a hardware abstraction layer (HAL) 480 based on a target. For example, in the hardware abstraction layer 480, programs (e.g., a module or a driver) designed to target hardware (e.g., the display 420, the camera 425, and/or the sensor 430) of the wearable device 200 may be classified. The framework layer 450 may be referred to as an XR framework layer in terms of including one or more programs for providing an extended reality (XR) service. For example, although FIG. 4 illustrates layers divided in the memory 415, the layers may be logically divided. However, it is not limited thereto. According to an embodiment, the layers may be stored in a specified area in the memory 415.

For example, in the framework layer 450, programs (e.g., a position tracker 471, a spatial perception unit 472 (or space recognizer), a gesture tracker 473, a gaze tracker 474, and/or a face tracker 475) designed to target at least one of the hardware abstraction layer 480 and/or the application layer 440 may be classified. The programs classified as the framework layer 450 may provide an application programming interface (API) executable based on another program.

For example, in the application layer 440, a program designed to target the user controlling the wearable device 200 may be classified. As an example of the programs classified as the application layer 440, an extended reality (XR) system user interface (UI) and/or an XR application 442 are exemplified, but an embodiment is not limited thereto. For example, the programs (e.g., a software application) classified as the application layer 440 may cause execution of a function supported by the programs classified as the framework layer 450 by calling an application programming interface (API).

For example, based on execution of the XR system UI 441, the wearable device 200 may display, on the display 420, one or more visual objects to perform interaction with a user for using a virtual space. The visual object may mean an object deployable in a screen for information transmission and/or interaction, such as text, an image, an icon, a video, a button, a checkbox, a radio button, a text box, a slider, and/or a table. The visual object may be referred to as a visual guide, a virtual object, a visual element, a UI element, a view object, and/or a view element. The wearable device 200 may provide a service capable of controlling functions available in the virtual space to the user based on the execution of the XR system UI 441.

Referring to FIG. 4, it is illustrated that a lightweight renderer 443 and/or an XR plug-in 444 are included in the XR system UI 441, but is not limited thereto. For example, the XR system UI 441 may cause execution of a function supported by the lightweight renderer 443 and/or the XR plug-in 444 included in the framework layer 450.

For example, the wearable device 200 may obtain a resource (e.g., an API, a system process, and/or a library) used to define, generate, and/or execute a rendering pipeline in which a partial change is allowed, based on execution of the lightweight renderer 443. The lightweight renderer 443 may be referred to as a lightweight render pipeline in terms of defining the rendering pipeline in which the partial change is allowed. The lightweight renderer 443 may include a renderer (e.g., a prebuilt renderer) built before execution of a software application. For example, the wearable device 200 may obtain a resource (e.g., an API, a system process, and/or a library) used to define, generate, and/or execute an entire rendering pipeline based on execution of the XR plug-in 444. The XR plug-in 444 may be referred to as an open XR native client in terms of defining (or setting) the entire rendering pipeline.

For example, the wearable device 200 may display, on the display 420, a screen representing at least a part of the virtual space based on execution of the XR application 442. An XR plug-in 444-1 included in the XR application 442 may may be referred to as the XR plug-in 444 of the XR system UI 441. Among descriptions of the XR plug-in 444-1, descriptions overlapping descriptions of the XR plug-in 444 may be omitted. The wearable device 200 may cause execution of a virtual space manager 451 based on execution of the XR application 442.

According to an embodiment, the wearable device 200 may provide a virtual space service based on the execution of the virtual space manager 451. For example, the virtual space manager 451 may include a platform (e.g., an Android platform) for supporting the virtual space service. Based on the execution of the virtual space manager 451, the wearable device 200 may display, on the display, a posture of a virtual object representing a posture of the user rendered by using data obtained via the sensor 430. The virtual space manager 451 may be referred to as a composition presentation manager (CPM).

For example, the virtual space manager 451 may include a runtime service 452. As an example, the runtime service 452 may be referred to as an OpenXR runtime module. Based on execution of the runtime service 452, the wearable device 200 may be used to provide at least one of a user pose prediction function, a frame timing function, and/or a spatial input function via the wearable device 200. As an example, the wearable device 200 may be used to perform rendering for the virtual space service to the user based on the execution of the runtime service 452. For example, based on the execution of the runtime service 452, an application (e.g., unity or OpenXR native application) may be implemented.

For example, the virtual space manager 451 may include a pass-through manager 453. Based on execution of the pass-through manager 453, the wearable device 200 may overlappingly display another screen representing a real space obtained via the camera 425 on at least a part of a screen while displaying the screen representing a virtual space on the display 420.

For example, the virtual space manager 451 may include an input manager 454. Based on execution of the input manager 454, the wearable device 200 may identify data (e.g., sensor data) obtained by executing one or more programs included in a perception service layer 470. The wearable device 200 may initiate execution of at least one of functions of the wearable device 200 by using the obtained data.

For example, the perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstract layer 460 may be referenced as OpenPX. The perception abstract layer 460 may be used for a perception client and a perception service.

According to an embodiment, the perception service layer 470 may include one or more programs for processing data obtained from the sensor 430 (or the camera 425). The one or more programs may include at least one of the position tracker 471, the spatial perception unit 472, the gesture tracker 473, the gaze tracker 474, and/or the face tracker 475. A type and/or the number of the one or more programs included in the perception service layer 470 is not limited to those illustrated in FIG. 4.

For example, based on execution of the position tracker 471, the wearable device 200 may identify a posture of the wearable device 200 using the sensor 430. Based on the execution of the position tracker 471, the wearable device 200 may identify a 6 degrees of freedom pose (6 dof pose) of the wearable device 200 by using data obtained using the camera 425 and the IMU. The position tracker 471 may be referred to as a head tracking (HeT) module.

For example, based on execution of the spatial perception unit 472, the wearable device 200 may be used to configure a surrounding environment of the wearable device 200 (or the user of the wearable device 200) into a three-dimensional virtual space. Based on the execution of the spatial perception unit 472, the wearable device 200 may reconstruct the surrounding environment of the wearable device 200 in three dimensions by using data obtained using the camera 425. The wearable device 200 may identify at least one of a plane, an inclination, and a step based on the surrounding environment of the wearable device 200 reconstructed in three dimensions based on the execution of the spatial perception unit 472. The spatial perception unit 472 may be referred to as a scene understanding (SU) module.

For example, the wearable device 200 may be used to identify (or perceive) a pose and/or a gesture of the hand of the user of the wearable device 200 based on execution of the gesture tracker 473. As an example, based on the execution of the gesture tracker 473, the wearable device 200 may identify the pose and/or the gesture of the hand of the user by using data obtained from the sensor 430. As an example, based on the execution of the gesture tracker 473, the wearable device 200 may identify the pose and/or the gesture of the hand of the user based on data (or an image) obtained using the camera. The gesture tracker 473 may be referred to as a hand tracking (HaT) module and/or a gesture tracking module.

For example, the wearable device 200 may identify (or track) movement of an eye of the user of the wearable device 200 based on execution of the gaze tracker 474. As an example, the wearable device 200 may identify the movement of the eye of the user by using data obtained from at least one sensor based on the execution of the gaze tracker 474. As an example, the wearable device 200 may identify the movement of the eye of the user based on data obtained using a camera (e.g., The gaze tracking camera 260-1 of FIGS. 2A and 2B) and/or an infrared light emitting diode (IR LED) based on the execution of the gaze tracker 474. The gaze tracker 474 may be referred to as an eye tracking (ET) module and/or a gaze tracking module.

For example, the perception service layer 470 of the wearable device 200 may further include the face tracker 475 for tracking a face of the user. For example, the wearable device 200 may identify (or track) movement of the face of the user and/or facial expression of the user based on execution of the face tracker 475. Based on the execution of the face tracker 475, the wearable device 200 may estimate the facial expression of the user based on the movement of the face of the user. As an example, based on the execution of the face tracker 475, the wearable device 200 may identify the movement of the face of the user and/or the facial expression of the user based on data (e.g., an image) obtained using a camera.

For embodiments described below, the wearable device 200 of FIG. 4 may be referenced. For example, the embodiments described below may be performed by the processor 410 of the wearable device 200 of FIG. 4.

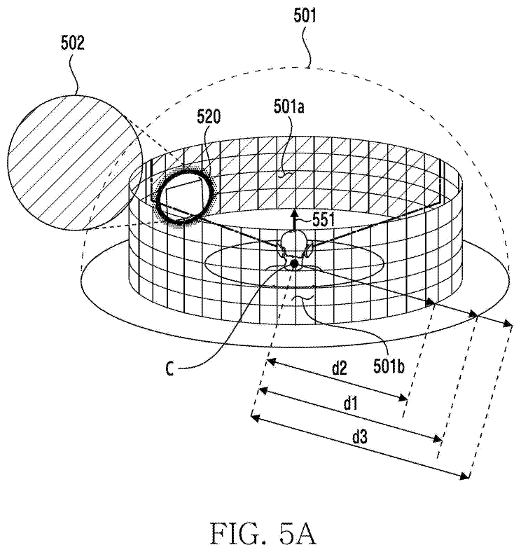

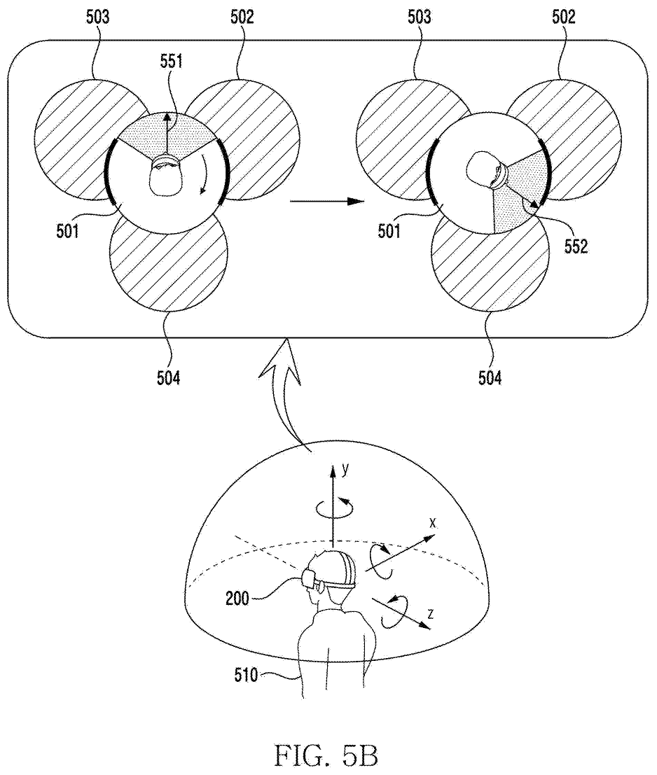

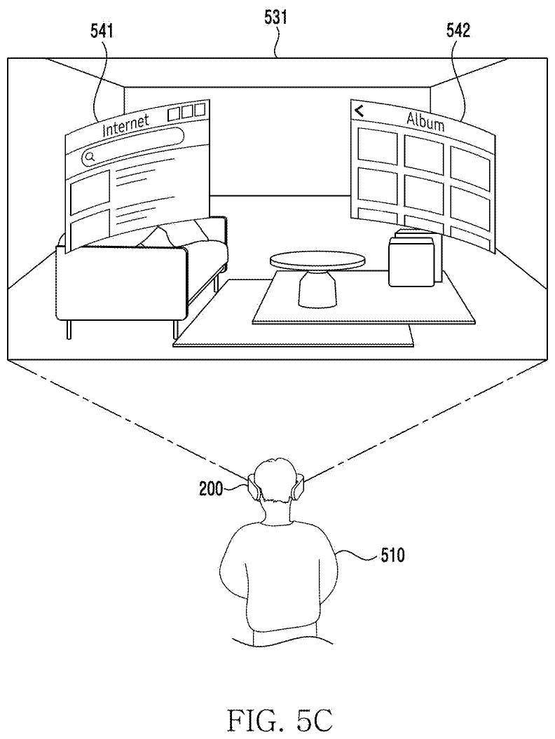

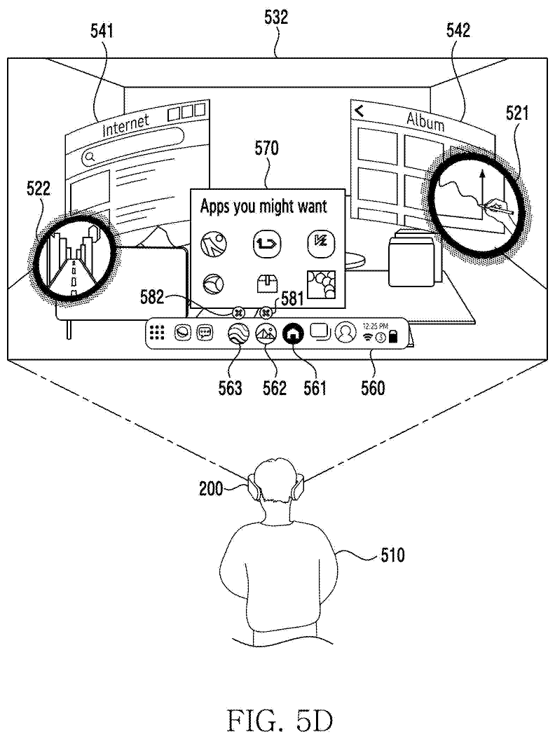

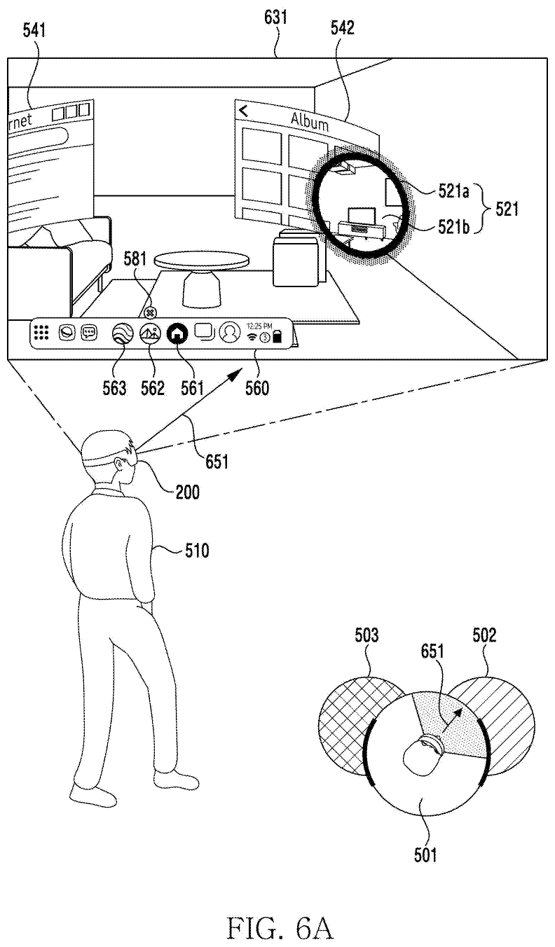

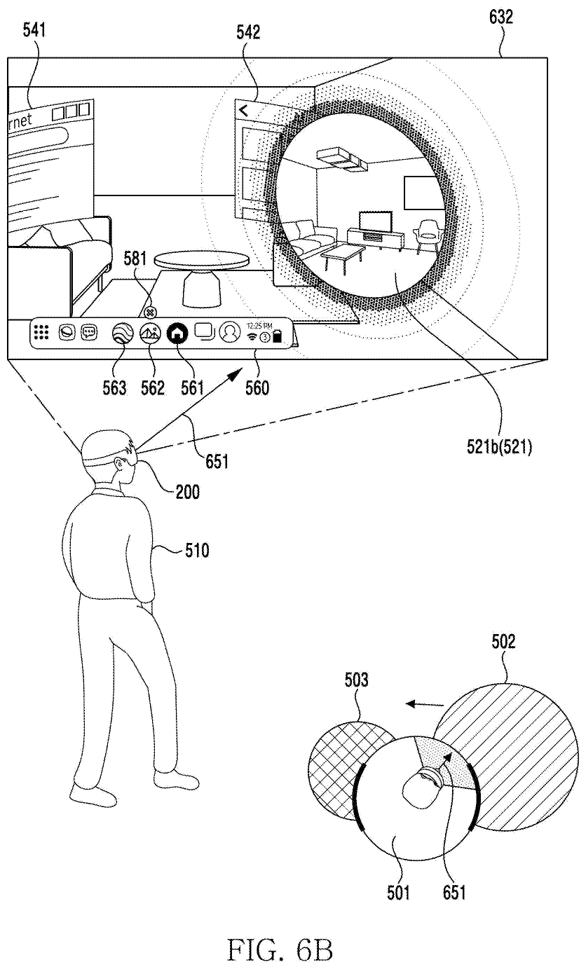

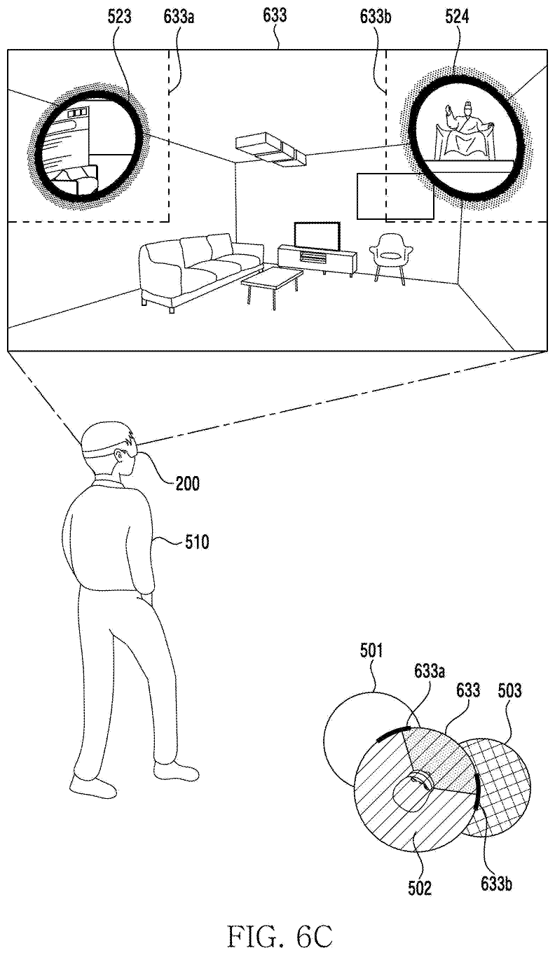

FIG. 5A illustrates an exemplary virtual space displayed through a display. FIG. 5B illustrates an example of an application within a virtual space displayed according to a direction of a gaze of a user. FIG. 5C and FIG. 5D illustrate an exemplary virtual space for execution of at least one application.

Referring to FIG. 5A, FIG. 5B, FIG. 5C, and FIG. 5D, the wearable device 200, in a state of being worn by a user 510, may include a camera (e.g., the camera 425 of FIG. 4) disposed toward a front of the user 510. The front of the user 510 may include a direction toward which a head of the user 510 and/or a gaze of the user 510 is directed. The wearable device 200 according to an embodiment, in a state of being worn by the user 510, may include a sensor (e.g., the sensor 430 of FIG. 4) for identifying a motion of the head of the user 510 and/or the wearable device 200.

A processor (e.g., the processor 410 of FIG. 4) of the wearable device 200 may identify an angle of the wearable device 200 based on data from the sensor 430. In order to provide a user interface (UI) based on virtual reality (VR), augmented reality (AR), and/or mixed reality (MR) to the user 510 wearing the wearable device 200, the processor 410 may control the camera 425 and/or the sensor 430. The UI may be related to a metaverse service and/or a notification service provided by the wearable device 200 and/or a server connected to the wearable device 200.

According to an embodiment, the processor 410 may execute a function related to augmented reality (AR) and/or mixed reality (MR). In a state in which the user 510 wears the wearable device 200, the wearable device 200 may include at least one lens disposed adjacent to eyes of the user 510. Ambient light passing through the lens may be combined (or mixed) with light emitted from the display (e.g., the display 420 of FIG. 4) of the wearable device 200. A display area of the display 420 may be formed within the lens through which the ambient light passes. Since the processor 410 combines the ambient light and the light emitted from the display 420, the user 510 may see an image in which a real object recognized by the ambient light and a virtual object formed by the light emitted from the display 420 are mixed.

According to an embodiment, the wearable device 200 may execute a function related to video see-through (VST) and/or virtual reality (VR). In a state in which the user 510 wears the wearable device 200, the wearable device 200 may include a housing covering the eyes of the user 510. The wearable device 200 may include, in the state, the display 420 disposed on a first surface (e.g., the first surface 310 of FIG. 3A) facing the eyes. The wearable device 200 may include the camera 425 (or the cameras 260-7, 260-8, 260-9, 260-10, 260-11, and 260-12 of FIG. 3B) disposed on a second surface (e.g., the second surface 320 of FIG. 3A) opposite to the first surface. Using the camera 425, the processor 410 may obtain frame images including ambient light. The processor 410 may output the frame images to the display 420 disposed on the first surface, allowing the user 510 to perceive the ambient light through the display 420. A display area of the display 420 disposed on the first surface may be formed by one or more pixels included in the display 420. The processor 410 may synthesize the virtual object into the frame images output through the display 420 so that the user 510 may perceive the virtual object together with a real object recognized by the ambient light.

According to an embodiment, the wearable device 200 may provide a user experience based on mixed reality (MR) using a virtual space. The processor 410 of the wearable device 200 may recognize an external space (e.g., a real space) in which the wearable device 200 is included, and generate a virtual space mapped to the external space. Space recognition performed by the processor 410 may include simultaneous localization and mapping (SLAM) and/or space mapping (e.g., scene understanding).

According to an embodiment, the processor 410 may display (or provide) a virtual space occupying a screen of the display 420 through the display 420. For example, the processor 410 may provide a virtual space including at least one virtual object through the display 420. The processor 410 may switch the virtual space occupying the screen to another virtual space based on a user input through the at least one virtual object and/or at least one visual object within the virtual space.

According to an embodiment, the processor 410 may display a first virtual space 501 corresponding to a first application through the display 420. For example, the first virtual space 501 may be referred to as a home space for executing at least one application. The display 420 may provide at least one virtual object and/or at least one visual object displayed within the first virtual space 501 to the user 510.

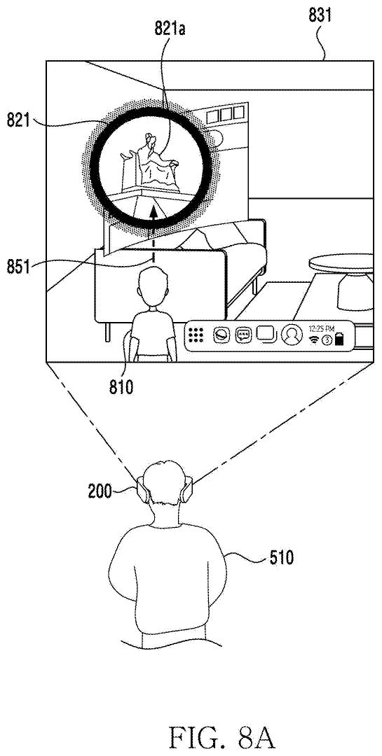

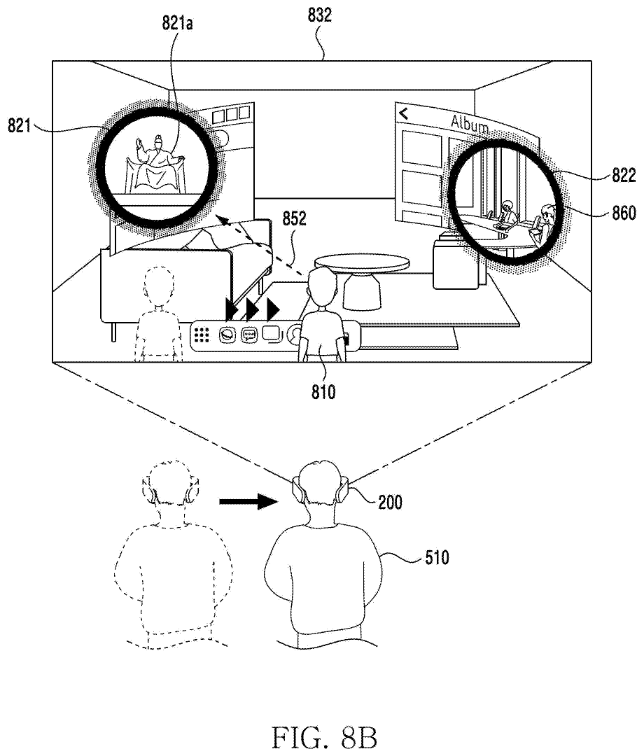

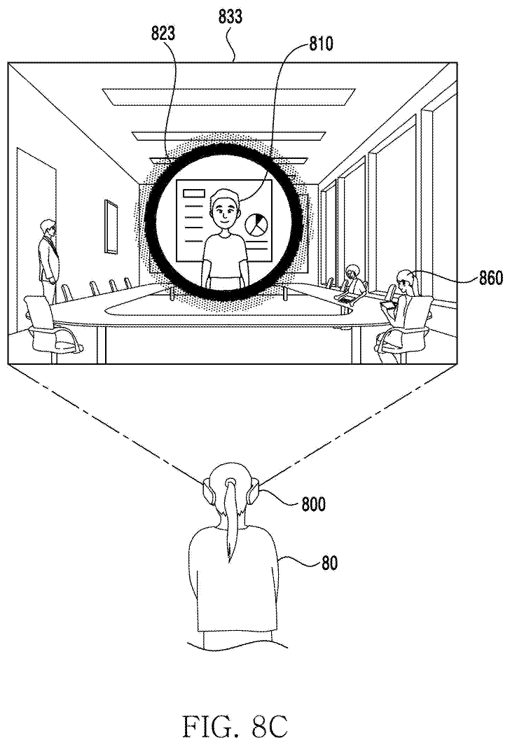

For example, the processor 410 may display the first virtual space 501 through the display 420 based on identifying an input regarding initiation of a service related to the virtual space to the user 510. The user 510 (or an avatar (e.g., a visual object 810 of FIG. 8A) corresponding to the user) may execute at least one of a plurality of applications capable of being provided through the wearable device 200 within the first virtual space 501.

For example, the processor 410 may provide a plurality of virtual spaces. For example, the processor 410 may provide not only the first virtual space 501 but also a second virtual space 502, a third virtual space 503, and a fourth virtual space 504. The virtual spaces 502, 503, and 504 may respectively correspond to applications being executed within the first virtual space 501. For example, the second virtual space 502 may be a virtual space provided by a second application based on execution of the second application. For example, although not illustrated, the third virtual space 503 may be a space provided by a third application being executed within the first virtual space 501. The fourth virtual space 504 may be a space provided by a fourth application being executed within the first virtual space 501.

According to an embodiment, the processor 410 may display, through the display 420, a least one virtual object 520 for entry into another virtual space corresponding to at least one application based on identifying at least one application being executed within a virtual space. The at least one application may be a description for including/representing one application or more than one application including, for example, the second application, the third application, and/or the fourth application.

For example, while the first virtual space 501 corresponding to the first application is displayed on the display 420, the processor 410 may display a first virtual object 521 for entry into the second virtual space 502 corresponding to the second application within the first virtual space 501 based on identifying an input for executing the second application. For example, in response to the input for executing the second application, the processor 410 may display the first virtual object 521 for entry into the second virtual space 502 corresponding to the second application within a screen (e.g., a screen 532 of FIG. 5D) displayed through the display 420.

Referring to FIG. 5A and FIG. 5B, the processor 410 may display, through the display 420, a portion of the first virtual space 501 based on a direction toward which a gaze of the user 510 wearing the wearable device 200 is directed. For example, the processor 410 may identify a field of view (FOV) of the user 510 within the first virtual space 501 detected by the sensor 430, based on the direction toward which the gaze of the user 510 is directed. The processor 410 may display, through the display, a screen corresponding to a portion of the first virtual space 501 that corresponds to the FOV detected by the sensor 430. For example, the processor 410 may identify the FOV corresponding to a direction 551 detected by the sensor 430, based on the direction 551 toward which the gaze of the user is directed. Based on identifying the FOV corresponding to the direction 551, the processor 410 may display, through the display 420, an area 501a of the first virtual space 501 that is displayable by the FOV. An area 501b extending from the area 501a of the first virtual space 501 may be at least partially displayed through the display 420 according to movement of the gaze of the user.

For example, based on the direction 551 toward which the gaze of the user 510 is directed, the processor 410 may display, through the display 420, the first virtual object 521 for entry into the second virtual space 502 corresponding to the second application within the first virtual space 501, and a second virtual object 522 for entry into the third virtual space 503 corresponding to the third application. For example, as the gaze of the user 510 moves, when the direction toward which the gaze is directed is changed from the direction 551 to a direction 552, the processor 410 may display, through the display, the first virtual object 521 for entry into the second virtual space 502 and a virtual object for entry into the fourth virtual space 504 based on the direction 552. The above-described embodiment is exemplary and is not limited thereto.

According to an embodiment, the processor 410 may change a size of the at least one virtual object 520 displayed within the first virtual space 501. The processor 410 may change the size of the at least one virtual object 520 within the first virtual space 501 using a distance related to a motion of the user 510 identified through the sensor 430.

For example, based on identifying an input for execution of at least one application within the first virtual space 501, the processor 410 may display the at least virtual object 520 in a first size at a position having a first distance d1 from a reference point C within the first virtual space 501. The reference point C may be a position corresponding to a position of the user 510 detected by the sensor 430 and/or a position of the avatar (e.g., the visual object 810 of FIG. 8A) corresponding to the user 510 within the first virtual space 501. Based on identifying that the gaze of the user 510 within the first virtual space 501 is directed toward the at least one virtual object 520, the processor 410 may display the at least one virtual object 520 in a second size larger than the first size at a position having a second distance d2 smaller than the first distance d1 from the reference point C. Based on identifying that the gaze of the user 510 within the first virtual space 501 is not directed toward the at least one virtual object 520, the processor 410 may display the at least one virtual object 520 in a third size smaller than the first size at a position having a third distance d3 greater than the first distance d1 from the reference point C. However, the above-described embodiment is exemplary and is not limited thereto.

Referring to FIG. 5C and FIG. 5D, the first virtual space 501 displayed through the display 420 based on the direction 551 of FIG. 5B is exemplarily illustrated through screens 531 and 532.

Referring to FIG. 5C, within the screen 531, the display 420 may display at least one visual object for at least one interface configured to execute a function of the first application within the first virtual space 501 displayed while the first application is being executed. For example, within the screen 531 displayed while the first application is being executed, the processor 410 may display a visual object 541 corresponding to a first interface for internet searching, and a visual object 542 corresponding to a second interface for searching a plurality of images stored in the wearable device 200. The visual objects 541 and 542 may be displayed within the first virtual space 501 while the first application is being executed, regardless of execution of at least one application within the first virtual space 501. For example, the visual objects 541 and 542 may be referred to as a dash (or a dashboard), but the above-described embodiment is exemplary and is not limited thereto.

Referring to FIG. 5D, within the screen 532, the display 420 may display the virtual objects 521 and 522 within the first virtual space 501 displayed while the first application is being executed based on a user input for executing the second application and/or a user input for executing the third application. For example, in response to the user input for executing the second application identified while the first application is being executed, the processor 410 may display, through the display 420, the first virtual object 521 for entry into the second virtual space 502 corresponding to the second application within the first virtual space 501 corresponding to the first application. For example, in response to the user input for executing the third application identified while the first application is being executed, the processor 410 may display, through the display 420, the second virtual object 522 for entry into the third virtual space 503 corresponding to the third application at a position spaced apart from the first virtual object 521 within the first virtual space 501.

According to an embodiment, based on identifying at least one application being executed while the first virtual space 501 is displayed, the processor 410 may display, through the display 420, a visual object 560 for displaying icons corresponding to a plurality of applications including the at least one application. For example, the visual object 560 may include an icon 561 representing the first application, an icon 562 representing the second application, and an icon 563 representing the third application. For example, the icon 561 may be displayed in a different color from the icons 562 and 563 to indicate that the first virtual space 501 is being displayed through the display 420 while the first virtual space 501 is displayed through the display 420. According to an embodiment, the visual object 560 may be referred to as one of a menu, a universal menu, a task bar, and a state bar, but is not limited thereto.

According to an embodiment, based on identifying an input for executing the second application and/or an input for executing the third application, the processor 410 may display, through the display 420, visual objects 581 and 582 for terminating the second application and/or the third application. For example, based on identifying the user input for executing the second application, the processor 410 may display, through the display 420, a visual object 581 for terminating the second application above the icon 562 representing the second application. Based on identifying an input for terminating the second application received through the visual object 581, the processor 410 may remove the first virtual object 521 for entry into the second virtual space corresponding to the second application within the first virtual space 501. For example, based on identifying the user input for executing the third application, the processor 410 may display, through the display 420, a visual object 582 for terminating the third application above the icon 563 representing the third application. Based on identifying an input for terminating the third application received through the visual object 582, the processor 410 may remove the second virtual object 522 for entry into the third virtual space corresponding to the third application within the first virtual space 501.

According to an embodiment, the processor 410 may store data related to applications executed according to a user input in memory 415. The processor 410 may display a visual object 570 for recommending and/or providing applications not stored in the wearable device 200 based on at least a portion of the data. Based on a user input through the visual object 570, the processor 410 may receive data related to the applications through an external electronic device (e.g., the electronic device 102 of FIG. 1) and/or a server (e.g., the server 108 of FIG. 1), or may download the applications into the memory 415.

Hereinafter, an example will be described in which the first virtual space 501 is switched to a virtual space provided by at least one application through the at least one virtual object 520, for entry into the virtual space provided by the at least one application from the first virtual space 501.

FIG. 6A, FIG. 6B, and FIG. 6C illustrate an example in which a virtual space is switched.

Hereinafter, redundant descriptions of configurations having the same reference numerals as those described above in FIG. 5A to FIG. 5D will be omitted.

Referring to FIG. 6A, a screen 631 displayed through a display 420 may be provided based on a direction 651 toward which a gaze of a user 510 is directed. According to an embodiment, when referring to FIG. 5A together, based on the direction 651, a first virtual object 521 may be moved from a position corresponding to a third distance d3 to a position corresponding to a first distance d1 within a first virtual space 501, or may be moved from the position corresponding to the first distance d1 to a position corresponding to a second distance d2. For example, the processor 410 may expand a size of the first virtual object 521 displayed through the display 420 based on the direction 651 toward which the gaze of the user is directed.

According to an embodiment, the processor 410 may display, through the display 420, a first virtual object 521 including a closed surface 521a displaying a portion of a second virtual space 502 provided from a second application based on a view angle within the first virtual space 501 identified by a sensor 430. For example, the processor 410 may display, through the display 420, the virtual object 521 including the closed surface 521a on which a video 521b displaying the portion of the second virtual space 502 corresponding to the second application is disposed, within the first virtual space 501, based on identifying a user input for executing the second application. Through the video 521b, the first virtual object 521 may represent information related to the second virtual space 502 provided by the second application and/or visual objects within the second virtual space 502.

Referring to FIG. 6A and FIG. 6B, the processor 410 may expand the size of the first virtual object 521 within the first virtual space 501 based on the direction 651 toward which the gaze of the user 510 is directed, and a motion of the user 510. For example, the processor 410 may expand a size of the video 521b included in the first virtual object 521 through the display 420 while identifying a user input for entry into the second virtual space 502 through the first virtual object 521 from the first virtual space 501. For example, the processor 410 may remove the closed surface 521a of the first virtual object 521 within a screen 632 provided while identifying the user input for entry into the second virtual space 502 through the first virtual object 521 from the first virtual space 501. For example, the user input for entry into the second virtual space 502 through the first virtual object 521 from the first virtual space 501 may include moving of the user 510 in the direction 651 toward which the gaze of the user 510 is directed, or staring of the user 510 in the direction 651 for a time greater than or equal to a specified time (e.g., a predefined time), but is not limited thereto.

Referring to FIG. 6C, an exemplary screen 633 provided after entry into the second virtual space 502 corresponding to the second application through the first virtual object 521 is illustrated. The processor 410 may display the second virtual space 502 on the display 420 based on an input for switching to the second virtual space 502 through the first virtual object 521.

For example, the input for switching to the second virtual space 502 through the first virtual object 521 may include a direction toward which the gaze of the user 510 detected by the sensor 430 of the wearable device 200 is directed (e.g., the direction 651 of FIG. 5A) and/or a motion of the user 510, but is not limited thereto. For example, the input for switching to the second virtual space 502 through the first virtual object 521 may include a specified utterance of the user 510 for switching a space and/or a gesture of pressing or selecting a visual object (e.g., a button or an image corresponding to the first virtual object 521) formed for switching a space displayed through the display 420. For example, when the input for switching to the second virtual space 502 through the first virtual object 521 is based on a motion of the user, a screen provided through the display 420 may be switched from the screen 631 to the screen 633 through the screen 632. For example, when the input for switching to the second virtual space 502 through the first virtual object 521 is based on a specified gesture (e.g., a click) of the user, a screen provided through the display 420 may be directly switched from the screen 631 to the screen 633.

According to an embodiment, in response to identifying the switching to the second virtual space 502, the processor 410 may display, on the display 420, a third virtual object 523 for entry into the first virtual space 501. For example, the processor 410 may display, on the display 420, the second virtual space 502 including the third virtual object 523 for switching to the first virtual space 501 based on or after previously receiving the input for switching to the second virtual space 502 through the first virtual object 521. For example, in response to identifying the switching to the second virtual space 502, the processor 410 may display, through the display 420, the third virtual object 523 corresponding to a first application being executed, and a fourth virtual object 524 corresponding to a third application.

According to an embodiment, in response to identifying the switching to the second virtual space 502, the processor 410 may display the third virtual object 523 corresponding to the first application and the fourth virtual object 524 corresponding to the third application at both ends of the screen 633 provided through the display 420 on which the second virtual space 502 is displayed. For example, in response to identifying the switching to the second virtual space 502, the processor 410 may display a third virtual object 523, and a fourth virtual object 524 within areas 633a and 633b disposed at both ends of the screen 633 provided through the display 420 on which the second virtual space 502 is displayed. The third virtual object 623 may be a virtual object for entry into the first virtual space 501 provided through the first application. The fourth virtual object 634 may be a virtual object for entry into a third virtual space 503 provided through the third application. According to an embodiment, virtual objects displayed within the areas 633a and 633b of the screen 633 provided through the switching to the second virtual space 502 may be virtual objects corresponding to applications interacted with through an input of the user 510, but are not limited thereto.

According to the above-described embodiment, the processor 410 of the wearable device 200 may provide an immersive user experience to the user 510 based on an input for switching from the first virtual space 501 to the second virtual space 502 through the first virtual object 521. The processor 410 may enhance immersion of the user 510 by displaying, in response to identifying the switching to the second virtual space 502, the third virtual object 523 corresponding to the first application at both ends of the screen 633 provided through the display 420 on which the second virtual space 502 is displayed.

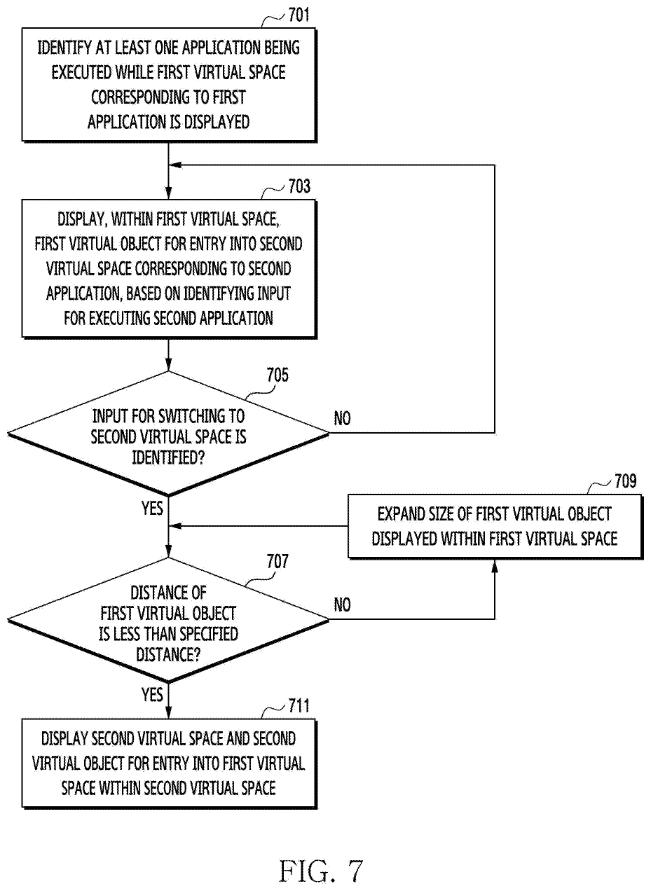

FIG. 7 is a flow chart illustrating an exemplary operation of a wearable device for switching a virtual space.

Operations of FIG. 7 may be performed by the electronic device 101 and/or the processor 120 of FIG. 1, the wearable device 200 of FIG. 2A, the wearable device 300 of FIG. 3A, or the wearable device 200 and/or the processor 410 executing the space recognizer 472 of FIG. 4.

Referring to FIG. 7, in operation 701, a processor of a wearable device may identify at least one application being executed while a first virtual space corresponding to a first application (e.g., the first virtual space 501 of FIG. 5A) is displayed. For example, the processor may display the first virtual space through a display based on identifying execution of a service for providing the virtual space. The processor may identify the at least one application being executed within the first virtual space while the first application is being executed.

In operation 703, the processor of the wearable device may display, within the first virtual space, a first virtual object (e.g., the first virtual object 521 of FIG. 5C) for entry into a second virtual space (e.g., the second virtual space 502 of FIG. 5A) corresponding to a second application, based on identifying an input for executing the second application. For example, the processor may display the first virtual object for entry into the second virtual space provided by the second application within a screen displaying a portion of the first virtual space provided through the display, based on identifying the input for executing the second application.

In operation 705, the processor of the wearable device may identify whether an input for switching to the second virtual space is identified. When the processor does not identify the input for switching to the second virtual space (705—NO), the processor may maintain performing operation 703. For example, the processor may identify the input for switching to the second virtual space through a direction toward which a gaze of a user is directed, a motion of the user, or a combination thereof.

In operation 707, the processor of the wearable device may identify whether a distance of the first virtual object is less than a specified distance. For example, when referring to FIG. 5A together, the processor may identify whether the distance of the first virtual object from a reference point C is less than a second distance d2. When the processor does not identify that the distance of (or to) the first virtual object is less than the specified distance (707—NO), the processor may perform operation 709.

In operation 709, the processor of the wearable device may expand a size of the first virtual object displayed within the first virtual space. For example, while identifying that the distance of the first virtual object related to a motion of the user is greater than or equal to the specified distance in operation 707, the processor may expand the size of the first virtual object within the first virtual space displayed through the display.

In operation 711, the processor of the wearable device may display the second virtual space and a second virtual object (e.g., the third virtual object 523 of FIG. 6C) for entry into the first virtual space within the second virtual space. For example, in response to entry into the second virtual space, the processor may display the second virtual object for entry into the first virtual space within the second virtual space provided through the display. For example, in response to entry into the second virtual space, the processor may display the second virtual object for entry into the first virtual space at an end of a screen provided through the display.

FIG. 8A, FIG. 8B, and FIG. 8C illustrate an exemplary virtual space displayed through a display.

Referring to FIG. 8A and FIG. 8B, screens 831 and 832 provided to a user 510 wearing the wearable device 200 are illustrated. The screens 831 and 832 may display a portion of a first virtual space (e.g., the first virtual space 501 of FIG. 5A) provided by a first application.

Referring to FIG. 8A, the processor 410 may display, through a display 420, a virtual object 821 for entry into a second virtual space (e.g., the second virtual space 502 of FIG. 5B) provided by a second application being executed, within a screen 831 in which the first virtual space 501 is displayed. According to an embodiment, the virtual object 821 may display a video including a visual object 821a included in the second virtual space 502.

According to an embodiment, based on a user input, the processor 410 may display, through the display 420, a visual object 810 corresponding to the user 510 wearing the wearable device 200 within the first virtual space 501. For example, the visual object 810 may be referred to as an avatar corresponding to the user 510.

Referring to FIG. 8A and FIG. 8B, a position of the visual object 810 corresponding to the user 510 within the first virtual space 501 may be changed based on a motion of the user 510. For example, the position of the visual object 810 corresponding to the user 510 within the first virtual space 501 may be moved based on movement of the user 510. A direction in which the visual object 810 faces the virtual object 821 may be changed from a direction 851 to a direction 852. As the direction in which the visual object 810 faces the virtual object 821 is changed, a shape of the visual object 821a within the second virtual space 502 provided by the virtual object 821 may be changed corresponding to the direction.

Referring to FIG. 8B and FIG. 8C, the wearable device 200 worn by the user 510 may be connected to another wearable device 800 worn by another user 80. For example, the processor 410 of the wearable device 200 may display a virtual object 822 for entry into a third virtual space (e.g., the third virtual space 503 of FIG. 5B) corresponding to a third application through the display 420 of the wearable device 200, based on identifying an input for executing the third application. A processor within the another wearable device 800 may be connected to the wearable device 200 in which the third application is being executed, through the third application, based on execution of the third application. For example, the another wearable device 800 may display a third virtual space 503 corresponding to the third application through a display of the another wearable device 800 while the third application is being executed. The another wearable device 800 may display a visual object 860 corresponding to the another user 80 wearing the another wearable device 800 within the third virtual space 503. The processor 410 of the wearable device 200 may display, through the virtual object 822 displayed within the first virtual space 501, the visual object 860 within the third virtual space 503 provided by the third application while the third application is being executed.

For example, the another wearable device 800 may display a virtual object 823 for entry into a first virtual space 501 corresponding to the first application within the third virtual space 503 through the display of the another wearable device 800. The another wearable device 800 may display, through the virtual object 823, a visual object 810 corresponding to the user 510 within the first space 501.

According to the above-described embodiment, the processor 410 of the wearable device 200 may provide an immersive user experience to the user 510 through virtual objects displaying visual objects within another virtual space different from a virtual space displayed through the display 420. The wearable device 200 may enhance immersion of the user by being connected to the another wearable device 800 through at least one application.

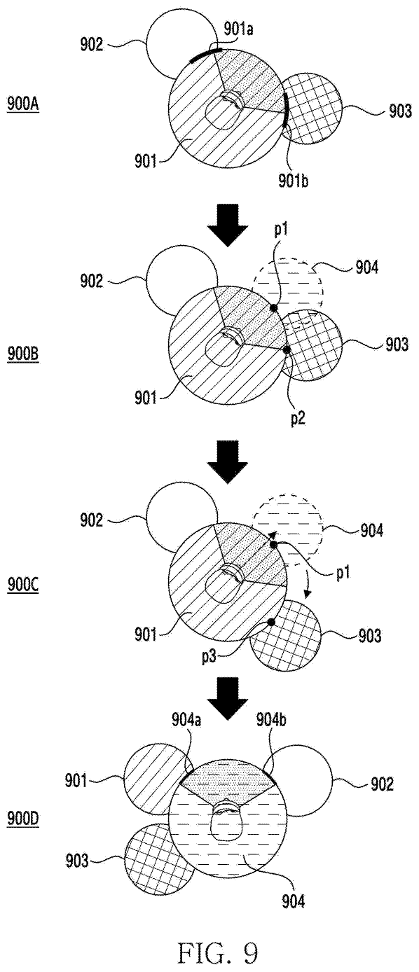

FIG. 9 illustrates an example of virtual objects disposed within a virtual space according to a user input.

Referring to FIG. 9, in a state 900A, a portion of a first virtual space 901 provided by a first application may be displayed through a display 420. While the first application is being executed, the processor 410 of the wearable device 200 may display a virtual object for switching to a second virtual space 902 provided by a second application, and a virtual object for switching to a third virtual space 903 provided by a third application on a screen provided through the display 420. The virtual objects may be respectively displayed within areas 901a and 901b of the first virtual space.

In a state 900B, a fourth application may be executed while the first application is being executed based on a user input. The processor 410 of the wearable device 200 may generate a virtual object for entry into a fourth virtual space 904 provided by the fourth application, at a first position p1 within the first virtual space 901, based on identifying an input for executing the fourth application. For example, the user input may include a gesture (e.g., a click) of a user for selecting an icon corresponding to the fourth application for executing the fourth application, or a drag-and-drop for disposing a visual object corresponding to the fourth application at the first position p1, but is not limited thereto. According to an embodiment, the processor 410 may maintain disposing the virtual object for entry into the third virtual space 903 at a second position p2, based on identifying that a distance between the first position p1 of the virtual object for entry into the fourth virtual space 904 and the second position p2 of a virtual object for entry into the third virtual space 903 is greater than or equal to a reference distance.

In a state 900C, the processor 410 may move the virtual object for entry into the third virtual space 903 from the second position p2 to a third position p3, based on identifying that the distance between the first position p1 of the virtual object for entry into the fourth virtual space 904 and the second position p2 of the virtual object for entry into the third virtual space 903 is less than the reference distance. The third position p3 may be a position spaced apart from the first position p1 of the virtual object for entry into the fourth virtual space 904 by the reference distance. In the state 900C, the processor 410 may identify a user input through the newly generated virtual object for entry into the fourth virtual space 904.

In a state 900D, in response to identifying the entry into the fourth virtual space 904, the processor 410 may respectively display virtual objects in areas 904a and 904b of the fourth virtual space 904 provided through the display 420. The virtual objects may include a virtual object for entry into the first virtual space 901 that was displayed through the display 420 before entry into the fourth virtual space 904. According to an embodiment, the processor 410 may display, in the areas 904a and 904b of the fourth virtual space 904 provided through the display 420, virtual objects corresponding to the first application and the second application that were interacted with based on a user input before entry into the fourth virtual space 904.

According to the above-described embodiment, a wearable device may comprise at least one sensor, a display, memory comprising one or more storage media storing instructions, and at least one processor comprising processing circuitry. The instructions, when executed by the at least one processor individually or collectively, may cause the wearable device to identify at least one application being executed while a first virtual space corresponding to a first application is displayed on the display. The instructions, when executed by the at least one processor individually or collectively, may cause the wearable device to, based on identifying an input for executing a second application, display a first virtual object for entry into a second virtual space corresponding to the second application within the first virtual space. The instructions, when executed by the at least one processor individually or collectively, may cause the wearable device to, based on an input for switching to the second virtual space through the first virtual object, display the second virtual space on the display. The instructions, when executed by the at least one processor individually or collectively, may cause the wearable device to, in response to identifying the switching to the second virtual space, display a second virtual object for entry into the first virtual space on the display.

For example, the instructions, when executed by the at least one processor individually or collectively, may cause the wearable device to display the first virtual object having a changeable size within the first virtual space using a distance related to a motion of a user identified through the at least one sensor. The instructions, when executed by the at least one processor individually or collectively, may cause the wearable device to expand the size of the first virtual object displayed within the first virtual space while identifying the input for switching to the second virtual space through the motion of the user. The instructions, when executed by the at least one processor individually or collectively, may cause the wearable device to, based on identifying the distance being less than a specified distance, display the second virtual space on the display.

For example, the instructions, when executed by the at least one processor individually or collectively, may cause the wearable device to change the size of the first virtual object displayed within the first virtual space based on a direction toward which a gaze of the user identified from the at least one sensor is directed. The instructions, when executed by the at least one processor individually or collectively, may cause the wearable device to display the first virtual object having a first size within the first virtual space based on a first direction toward which the gaze of the user is directed. The instructions, when executed by the at least one processor individually or collectively, may cause the wearable device to display the first virtual object having a second size smaller than the first size within the first virtual space based on a second direction different from the first direction toward which the gaze of the user is directed.

For example, the instructions, when executed by the at least one processor individually or collectively, may cause the wearable device to display a visual object including a plurality of icons respectively corresponding to a plurality of executable applications while the first virtual space is displayed on the display. The instructions, when executed by the at least one processor individually or collectively, may cause the wearable device to, based on identifying the at least one application being executed, display a visual object for terminating the at least one application among the plurality of applications through the visual object.

For example, the instructions, when executed by the at least one processor individually or collectively, may cause the wearable device to display the first virtual object including a closed surface displaying a portion of the second virtual space provided from the second application based on a view angle within the first virtual space identified by the at least one sensor.

For example, the instructions, when executed by the at least one processor individually or collectively, may cause the wearable device to, while identifying the input for switching to the second virtual space, expand the portion of the second virtual space displayed through the virtual object and remove the closed surface within the first virtual space.

For example, the instructions, when executed by the at least one processor individually or collectively, may cause the wearable device to display the first virtual object at a first position within the first virtual space. The instructions, when executed by the at least one processor individually or collectively, may cause the wearable device to, based on identifying an input for executing a third application, display a third virtual object for entry into a third virtual space corresponding to the third application at a second position within the first virtual space. The instructions, when executed by the at least one processor individually or collectively, may cause the wearable device to, based on identifying that a distance between the first position and the second position is greater than or equal to a reference distance, maintain displaying the third virtual object at the second position. The instructions, when executed by the at least one processor individually or collectively, may cause the wearable device to, based on identifying that the distance between the first position and the second position is less than the reference value, move the third virtual object to a third position spaced apart from the first position by the reference distance.

For example, the instructions, when executed by the at least one processor individually or collectively, may cause the wearable device to, in response to identifying the switching to the second virtual space, display the second virtual object and a fourth virtual object for entry into the third virtual space at both ends of a screen provided through the display on which the second virtual space is displayed.

For example, the instructions, when executed by the at least one processor individually or collectively, may cause the wearable device to, based on identifying that the number of applications being executed exceeds the number of virtual objects displayable on the display within a screen provided after entry into the second virtual space, display virtual objects corresponding to a portion of the applications. The instructions, when executed by the at least one processor individually or collectively, may cause the wearable device to display virtual objects corresponding to a remaining portion of the applications within the second virtual space based on a direction toward which a gaze of the user identified through the at least one sensor is directed.

According to an embodiment, a method of a wearable device may comprise identifying at least one application being executed while a first virtual space corresponding to a first application is displayed on a display of the wearable device. The method may comprise, based on identifying an input for executing a second application, displaying a first virtual object for entry into a second virtual space corresponding to the second application within the first virtual space. The method may comprise, based on an input for switching to the second virtual space through the first virtual object, displaying the second virtual space on the display. The method may comprise, in response to identifying the switching to the second virtual space, displaying a second virtual object for entry into the first virtual space on the display.

For example, the displaying the first virtual object may comprise displaying the first virtual object having a changeable size within the first virtual space using a distance related to a motion of a user identified through at least one sensor. The displaying the first virtual object may comprise expanding the size of the virtual object displayed within the first virtual space while identifying the input for switching to the second virtual space through the motion of the user. The displaying the second virtual space may comprise, based on identifying the distance being less than a specified distance, displaying the second virtual space on the display.

For example, the method may further comprise changing the size of the first virtual object displayed within the first virtual space based on a direction toward which a gaze of the user identified from the at least one sensor is directed. Displaying the first virtual object may comprise displaying the first virtual object having a first size within the first virtual space based on a first direction toward which the gaze of the user is directed. Displaying the first virtual object may comprise displaying the first virtual object having a second size smaller than the first size within the first virtual space based on a second direction different from the first direction toward which the gaze of the user is directed.

For example, the method may further comprise displaying a visual object including a plurality of icons respectively corresponding to a plurality of executable applications while the first virtual space is displayed on the display. The method may further comprise, based on identifying the at least one application being executed, displaying a visual object for terminating the at least one application among the plurality of applications through the visual object.

For example, the displaying the first virtual object may comprise displaying the first virtual object including a closed surface displaying a portion of the second virtual space provided from the second application based on a view angle within the first virtual space identified by the at least one sensor.

For example, The displaying the first virtual object may further comprise expanding the portion of the second virtual space displayed through the virtual object and removing the closed surface within the first virtual space while identifying the input for switching to the second virtual space.

For example, the displaying the first virtual object may further comprise displaying the first virtual object at a first position within the first virtual space. The displaying the first virtual object may further comprise based on identifying an input for executing a third application, displaying a third virtual object for entry into a third virtual space corresponding to the third application at a second position within the first virtual space. The displaying the first virtual object may further comprise based on identifying that a distance between the first position and the second position is greater than or equal to a reference distance, maintaining displaying the third virtual object at the second position. The displaying the first virtual object may further comprise based on identifying that the distance between the first position and the second position is less than a reference value, moving the third virtual object to a third position spaced apart from the first position by the reference distance.

For example, the method may further comprise displaying the second virtual object may comprise, in response to identifying the switching to the second virtual space, displaying the second virtual object and a fourth virtual object for entry into the third virtual space at both ends of a screen provided through the display on which the second virtual space is displayed.

For example, the method may further comprise, based on identifying that the number of applications being executed exceeds the number of virtual objects displayable on the display within a screen provided after entry into the second virtual space, displaying virtual objects corresponding to a portion of the applications. The method may further comprise displaying virtual objects corresponding to a remaining portion of the applications within the second virtual space based on a direction toward which a gaze of the user identified through the at least one sensor is directed.

According to an embodiment, in a non-transitory computer readable storage medium storing one or more programs, the one or more programs may include instructions that, when executed by at least one processor of a wearable device with a display and at least one sensor, individually or collectively, cause the wearable device to identify at least one application being executed while a first virtual space corresponding to a first application is displayed on the display. The one or more programs may include instructions that, when executed by the at least one processor individually or collectively, cause the wearable device to, based on identifying an input for executing a second application, display a first virtual object for entry into a second virtual space corresponding to the second application within the first virtual space. The one or more programs may include instructions that, when executed by the at least one processor individually or collectively, cause the wearable device to, based on an input for switching to the second virtual space through the first virtual object, display the second virtual space on the display. The one or more programs may include instructions that, in response to identifying the switching to the second virtual space, cause the wearable device to display a second virtual object for entry into the first virtual space on the display.

For example, the one or more programs may include instructions that, when executed by the at least one processor of the wearable device individually or collectively, cause the wearable device to display the first virtual object having a changeable size within the first virtual space using a distance related to a motion of a user identified through the at least one sensor. The one or more programs may include instructions that, when executed by the at least one processor of the wearable device individually or collectively, cause the wearable device to expand the size of the virtual object displayed within the first virtual space while identifying the input for switching to the second virtual space through the motion of the user. The one or more programs may include instructions that, when executed by the at least one processor individually or collectively, cause the wearable device to, based on identifying the distance being less than a specified distance, display the second virtual space on the display.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A wearable device comprising:
at least one sensor;
a display;
at least one processor comprising processing circuitry; and
memory comprising one or more storage mediums storing instructions,
wherein the instructions, when executed by the at least one processor individually or collectively, cause the wearable device to:
identify at least one application being executed while a first virtual space corresponding to a first application is displayed on the display;
based on identifying an input for executing a second application, display a first virtual object for entry into a second virtual space corresponding to the second application within the first virtual space;
based on an input for switching to the second virtual space through the first virtual object, display the second virtual space on the display; and
in response to identifying the switching to the second virtual space, display a second virtual object for entry into the first virtual space on the display.

2. The wearable device of claim 1,
wherein the instructions, when executed by the at least one processor individually or collectively, cause the wearable device to:
display the first virtual object having a size changeable within the first virtual space using a distance related to a motion of a user identified through the at least one sensor;
expand the size of the first virtual object displayed within the first virtual space while identifying the input for switching to the second virtual space through the motion of the user; and
based on identifying the distance being less than a specified distance, display the second virtual space on the display.

3. The wearable device of claim 2,
wherein the instructions, when executed by the at least one processor individually or collectively, cause the wearable device to:
change the size of the first virtual object displayed within the first virtual space based on a direction toward which a gaze of the user identified from the at least one sensor is directed;
display the first virtual object having a first size within the first virtual space based on a first direction toward which the gaze of the user is directed; and
display the first virtual object having a second size smaller than the first size within the first virtual space based on a second direction different from the first direction toward which the gaze of the user is directed.

4. The wearable device of claim 1,
wherein the instructions, when executed by the at least one processor individually or collectively, cause the wearable device to:
display a visual object including a plurality of icons respectively corresponding to a plurality of applications while the first virtual space is displayed on the display; and
based on identifying the at least one application being executed, display a visual object for terminating the at least one application among the plurality of applications through the visual object.

5. The wearable device of claim 1,
wherein the instructions, when executed by the at least one processor individually or collectively, cause the wearable device to:
display the first virtual object including a closed surface displaying a portion of the second virtual space provided from the second application based on a view angle within the first virtual space identified by the at least one sensor.

6. The wearable device of claim 5,
wherein the instructions, when executed by the at least one processor individually or collectively, cause the wearable device to:
expand the portion of the second virtual space displayed through the virtual object and remove the closed surface within the first virtual space while identifying the input for switching to the second virtual space.

7. The wearable device of claim 1,
wherein the instructions, when executed by the at least one processor individually or collectively, cause the wearable device to:
display the first virtual object at a first position within the first virtual space;
based on identifying an input for executing a third application, display a third virtual object for entry into a third virtual space corresponding to the third application at a second position within the first virtual space;
based on identifying that a distance between the first position and the second position is greater than or equal to a reference distance, maintain displaying the third virtual object at the second position; and
based on identifying that the distance between the first position and the second position is less than the reference distance, move the third virtual object to a third position spaced apart from the first position by the reference distance.

8. The wearable device of claim 7,
wherein the instructions, when executed by the at least one processor individually or collectively, cause the wearable device to:
in response to identifying the switching to the second virtual space, display the second virtual object and a fourth virtual object for entry into the third virtual space at both ends of a screen provided through the display on which the second virtual space is displayed.

9. The wearable device of claim 1,
wherein the instructions, when executed by the at least one processor individually or collectively, cause the wearable device to:
based on identifying that a number of applications being executed exceeds a number of virtual objects displayable on the display within a screen provided after entry into the second virtual space, display virtual objects corresponding to a portion of the applications; and
display virtual objects corresponding to a remaining portion of the applications within the second virtual space based on a direction toward which a gaze of a user identified through the at least one sensor is directed.

10. A method of a wearable device, comprising:
identifying at least one application being executed while a first virtual space corresponding to a first application is displayed on a display of the wearable device;
based on identifying an input for executing a second application, displaying a first virtual object for entry into a second virtual space corresponding to the second application within the first virtual space;
based on an input for switching to the second virtual space through the first virtual object, displaying the second virtual space on the display; and
in response to identifying the switching to the second virtual space, displaying a second virtual object for entry into the first virtual space on the display.

11. The method of claim 10,
wherein the displaying the first virtual object comprises:
displaying the first virtual object having a size changeable within the first virtual space using a distance related to a motion of a user identified through at least one sensor of the wearable device; and
expanding the size of the first virtual object displayed within the first virtual space while identifying the input for switching to the second virtual space through the motion of the user, and
wherein displaying the second virtual space comprises:
based on identifying the distance being less than a specified distance, displaying the second virtual space on the display.

12. The method of claim 11, further comprising:
changing the size of the first virtual object displayed within the first virtual space based on a direction toward which a gaze of the user identified from at least one sensor of the wearable device is directed,
wherein displaying the first virtual object comprises:
displaying the first virtual object having a first size within the first virtual space based on a first direction toward which the gaze of the user is directed; and
displaying the first virtual object having a second size smaller than the first size within the first virtual space based on a second direction different from the first direction toward which the gaze of the user is directed.

13. The method of claim 10, further comprising:
displaying a visual object including a plurality of icons respectively corresponding to a plurality of applications while the first virtual space is displayed on the display; and
based on identifying the at least one application being executed, displaying a visual object for terminating the at least one application among the plurality of applications through the visual object.

14. The method of claim 10,
wherein the displaying the first virtual object further comprises:
displaying the first virtual object including a closed surface displaying a portion of the second virtual space provided from the second application based on a view angle within the first virtual space identified by at least one sensor.

15. The method of claim 14,
wherein the displaying the first virtual object further comprises:
expanding the portion of the second virtual space displayed through the virtual object and removing the closed surface within the first virtual space while identifying the input for switching to the second virtual space.

16. The method of claim 10,
wherein the displaying the first virtual object further comprises:
displaying the first virtual object at a first position within the first virtual space;
based on identifying an input for executing a third application, displaying a third virtual object for entry into a third virtual space corresponding to the third application at a second position within the first virtual space;
based on identifying that a distance between the first position and the second position is greater than or equal to a reference distance, maintaining displaying the third virtual object at the second position; and
based on identifying that the distance between the first position and the second position is less than the reference distance, moving the third virtual object to a third position spaced apart from the first position by the reference distance.

17. The method of claim 16, further comprising:
in response to identifying the switching to the second virtual space, displaying a fourth virtual object for entry into the third virtual space at both ends of a screen provided through the display on which the second virtual space is displayed.

18. The method of claim 10, further comprising:
based on identifying that a number of applications being executed exceeds a number of virtual objects displayable on the display within a screen provided after entry into the second virtual space, displaying virtual objects corresponding to a portion of the applications; and
displaying virtual objects corresponding to a remaining portion of the applications within the second virtual space based on a direction toward which a gaze of a user identified through at least one sensor is directed.

19. A non-transitory computer readable storage medium storing one or more programs including instructions,
wherein the instructions, when executed by at least one processor of a wearable device including at least one sensor, and a display, individually or collectively, cause the wearable device to:
identify at least one application being executed while a first virtual space corresponding to a first application is displayed on the display;
based on identifying an input for executing a second application, display a first virtual object for entry into a second virtual space corresponding to the second application within the first virtual space;
based on an input for switching to the second virtual space through the first virtual object, display the second virtual space on the display; and
in response to identifying the switching to the second virtual space, display a second virtual object for entry into the first virtual space on the display.

20. The non-transitory computer readable storage medium of claim 19,
wherein the instructions, when executed by the at least one processor individually or collectively, cause the wearable device to:
display the first virtual object having a size changeable within the first virtual space using a distance related to a motion of a user identified through the at least one sensor;
expand the size of the first virtual object displayed within the first virtual space while identifying the input for switching to the second virtual space through the motion of the user; and
based on identifying the distance being less than a specified distance, display the second virtual space on the display.
